(19) United States
(12) Patent Application Publication
(10) Pub. No.: US 2026/0169784 A1
(43) Pub. Date: Jun. 18, 2026

(54) RENEWING LAYERS OF A CONTAINER WITHOUT RESTARTING

(71) Applicant: International Business Machines Corporation, Armonk, NY (US)

(72) Inventors: Xiao Ling Chen, Beijing (CN); Yong Yin, Poughkeepsie, NY (US); Heng Wang, Beijing (CN); Qun Wei, Beijing (CN)

(21) Appl. No.: 18/985,180

(22) Filed: Dec. 18, 2024

(51) Int. Cl. G06F 9/455

(52) U.S. Cl. CPC G06F 9/45558; G06F 2009/45591

(57) ABSTRACT

Examples described herein provide a computer-implemented method that includes downloading a container image from an image repository. The method further includes deploying the container image as a container at a local graph. The method further includes identifying an image layer of the container image of the container as having a patch in error. The method further includes marking, at the image repository, the image layer as having the patch in error by modifying attributes of a manifest configuration for the image layer having the patch in error. The method further includes renewing the image layer with the patch in error on the local graph by setting a renewal attribute for the image layer having the patch in error to a renewal state.

### BACKGROUND

The present disclosure relates to computing systems, and more specifically, to renewing layers of a container without restarting.

Containers provide an application layer approach to virtualization. A container packages together code and its dependencies, and the container can be run on a physical processing system. Multiple containers can be run on the same physical processing system. This approach uses less resources than a virtual machine approach to virtualization.

### SUMMARY

According to an embodiment, a computer-implemented method is provided. The method includes downloading a container image from an image repository. The method further includes deploying the container image as a container at a local graph. The method further includes identifying an image layer of the container image of the container as having a patch in error. The method further includes marking, at the image repository, the image layer as having the patch in error by modifying attributes of a manifest configuration for the image layer having the patch in error. The method further includes renewing the image layer with the patch in error on the local graph by setting a renewal attribute for the image layer having the patch in error to a renewal state.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a computing environment according to an embodiment;

FIG. 2 illustrates an image and a container, each with layers according to an embodiment;

FIG. 3 illustrates a block diagram of an architecture of an image and containers, each with layers according to an embodiment;

FIG. 4 illustrates a block diagram of a system for recovering layers of a container using an online patch in error layer renewal (OPELRN) engine, according to an embodiment;

FIG. 5 illustrates a block diagram of an architecture for renewing layers of a container without restarting according to an embodiment;

FIG. 6 illustrates a block diagram of a layer of an image having attributes for renewing layers of a container without restarting according to an embodiment;

FIG. 7 illustrates a block diagram of a schema for addressing of container layers with renewal layer for renewing layers of a container without restarting according to an embodiment;

FIG. 8 illustrates a flow diagram of a method for renewing layers of a container without restarting according to an embodiment; and

FIG. 9 illustrates a flow diagram of a method for renewing layers of a container without restarting according to an embodiment.

The detailed description explains embodiments of the disclosure, together with advantages and features, by way of example with reference to the drawings.

### DETAILED DESCRIPTION

One or more embodiments described herein relate to renewing layers of a container without restarting.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

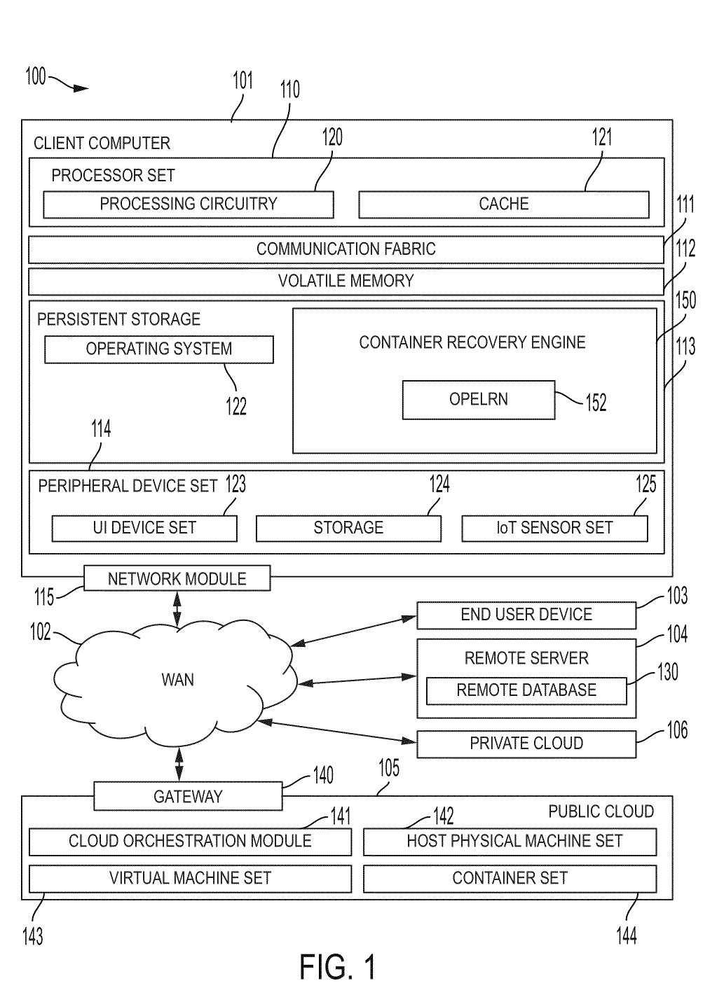

FIG. 1 illustrates a computing environment 100, according to an embodiment. Computing environment 100 contains an example of an environment for the execution of at least some of the computer code involved in performing the inventive methods, such as a container engine 150, which may be used for recovering layers of a container. The container engine 150 may include an online patch in error layer renewal engine (OPELRN) engine 152. In addition to container engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and container engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in container engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in container engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Containers package together code and its dependencies to provide for virtualization. Some approaches to implementing containers involve packaging the contents of image layers into an image and pushing the image to an image repository. The image can then be pulled from the image repository to be implemented on other systems, such as by end users. When pulling an image from the image repository, the contents of the image layers and any parent layers for the image are downloaded to a local graph. Once downloaded, the image can be stored on a local graph and deployed as a container. In other words, the layers of the image are uploaded to the image repository and then those layers are later downloaded to one or more local graphs for deployment as a container.

In some cases, patches may be released to fix bugs or add functionality to an image. For example, after an image is released (e.g., uploaded to the image repository), an error may be identified in the image, and a patch may be released to address the error. In such cases, a patch itself may have an error, which is referred to as a “patch in error.” It is often not possible for a user to remove the patch in error immediately a higher version is used in the user’s production environment. For example, to fix an issue identified in an older layer (e.g., layer 3 (L3)) of an image, a fix patch can be delivered on a newer layer (e.g., layer 5 (L5)) of the image. It may be discovered thereafter that the fixes on the newer layer (e.g., L5) trigger other errors, thus the original patch was a patch in error. In this case, developers and testers on service providers or customers usually exploit several different containers to reproduce the issue and verify the fixes separately. Although some approach to recover or rebase a layer with a patch in error on exploited containers. However, what is needed is the ability to reproduce the issue and verify the fixes on the same exploited container quickly.

One or more embodiments described herein address these and other shortcomings by providing for renewing layers of a container without restarting. Such one or more embodiments provide the ability to reproduce an issue and verify fixes on the same exploited container quickly in a container environment. More particularly, one or more embodiments described herein provide for renewing a layer with a patch in error on a local image or exploited container quickly and efficiently without the need to restart the Docker service or run multiple containers. This is achieved by introducing a new attribute, “diff-renewal,” under the cacheID of the layer to be renewed and relocating the layer’s “diff folder” to this new attribute. One or more embodiments introduces a new command, “docker renew specified layer with a new target layer,” which invokes the OPELRN engine 152 to handle the renewal process. This approach enables users to reproduce issues and verify fixes on the same exploited container, enhancing the robustness and security of enterprise-level production environments.

As used herein, “diff” (also referred to as “diff folder”) refers to a folder that stores a “diffID” and is used to check layer items on a root file system via a command “docker inspect image layer checksum ID,” which is obtained by calculating a tar data checksum of the image layer “diff” folder. The “diff” stores information about the content of a layer, such as updated file, new file, removed file, directory file, and/or the like, including combinations and/or multiples thereof. The “diffID” is a unique identifier that identifies the layers of the image

According to one or more embodiments, the OPELRN engine 152 is used to renew the layer with patch in error on local storage by moving its fixed layer’s diff folder to the cacheID directory and relocating diff-relocation to diff-renewal. This process is performed as follows according to an embodiment: pull and exploit new fix target layer from the registry using addressing (e.g., diffID/chainID/cacheID); introduce new attribute “diff-renewal” under the storage level diff-relocation for layer with patch in error; move the target layer’s diff folder under cacheID to the layer with patch in error; and make the layer with patch in error’s diff-relocation point to diff-renewal.

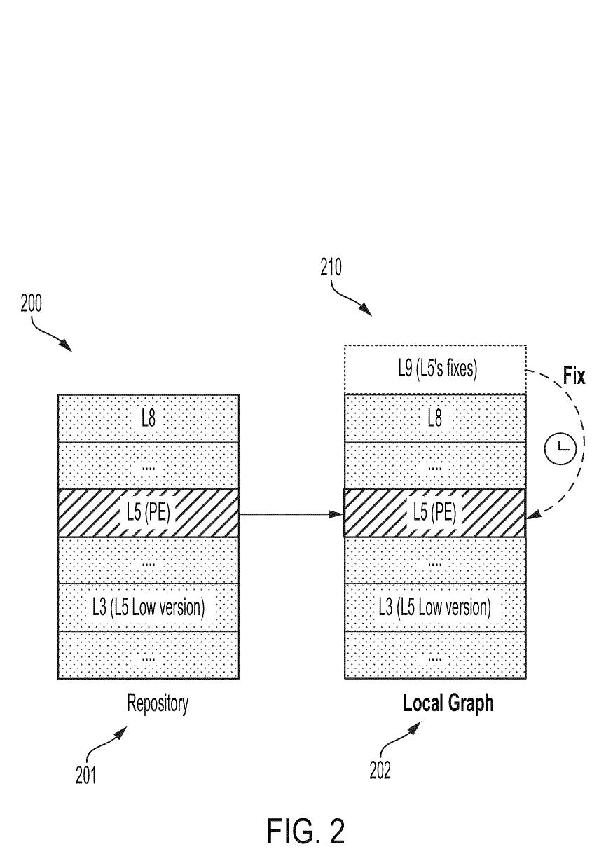

Turning now to FIG. 2, a container image 200 and a container 210, each with layers, are shown, according to an embodiment. The container image 200 is stored in an image repository 201 and can be downloaded to and installed on a local graph 202 as the container 210. In FIG. 2, the container image 200 and the container 210 are shown as having multiple layers, including layers L3, L5, and L8, among others.

A container image (e.g., the container image 200) is a standalone executable software package that includes the information needed to run a piece of software, including the code, runtime, system tools, libraries, and settings. Container images are used to create containers, which are instances of the container images running as isolated processing on a host operating system (e.g., the operating system 122). For example, the container image 200 is used to create the container 210. According to an embodiment, the container 210 is a container image pulled from the image repository 201 to the local graph 202. According to another embodiment, consider the following example. Docker mounts layers (e.g., a base layer, layer L1, … Layer L7, Layer L8) at one mount point. These are called image layers, and the container 210 exploited with this image can share the image layers (e.g., read-only layers) and have their own container layer (read-write layer). For example, Docker runs three containers C1, C2, C3 with image I1, then the containers C1, C2, C3 share the image layers of I1, which is stored in local graph 202 as the container 210 shown.

If a patch in error (PE) is deployed to one of the layers (e.g., to the layer L5 as shown in FIG. 2), it may take time for a new fix to be implemented as a new layer of the container 210 of FIG. 2 (e.g., layer L9, which represents L5’s fixes). In some cases, the new layer (e.g., layer L9) may take weeks or even months to be implemented, thus causing the container 210 to function improperly (e.g., using the patch in error at layer L5) until the fix is implemented.

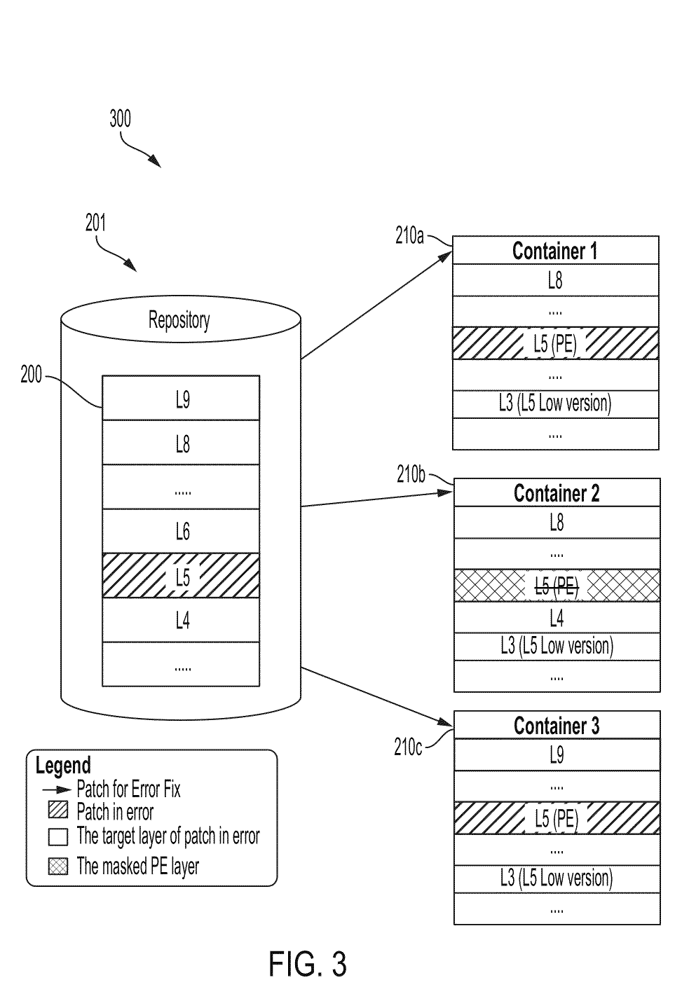

FIG. 3 illustrates a block diagram an architecture 300 of an image and containers, each with layers according to an embodiment. The architecture 300 includes the image repository 201, which stores the container image 200. The layers in the container image 200 include, for example, layers L3, L4, L5, L6, L8, and L9, among others. Layer L5 contains a patch in error (PE), and layer L9 represents the fix to the patch in error on layer L5.

In existing systems, to reproduce and verify fixes as described herein, three separate containers are exploited, including container 1210a, container 2210b, and container 3210c. Container 1 210a includes layers L3, L5 (which includes the patch in error), and L8. This container is exploited to reproduce the patch in error identified on L5. Container 2 210b includes layers L3, L4, and L8. This container is exploited to recover the patch in error identified on L5 by masking L5. Container 3 210c includes layers L3, L5 (PE), and L9. This container is exploited to verify the fixes to L5 delivered on L9, which is a fix for the PE layer L5 (e.g., a patch for error fix).

It is desirable to streamline this approach to enable users to reproduce issues and verify fixes on the same exploited container, which enhances the robustness and security of enterprise-level production environments.

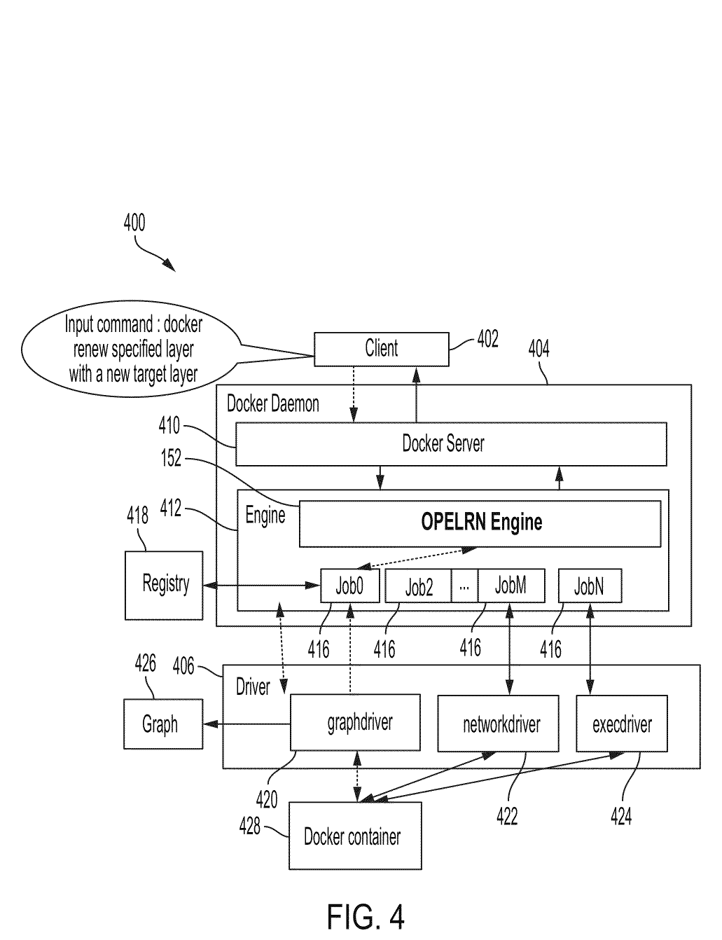

FIG. 4 illustrates a block diagram of a system 400 for recovering layers of a container using the OPELRN engine 152 of FIG. 1, according to an embodiment. The system 400 includes several components that work together to achieve the renewal of a specified layer with a new target layer without restarting the container service.

The system 400 includes a client 402 in combination with a docker daemon 404, which in turn is in communication with a driver.

The client 402 sends commands to a docker server 410 of the docker daemon 404. One such command is a layer renewal command to renew a specified layer with a new target layer. The layer renewal command is represented as “docker renew specified layer with a new target layer.”

The docker daemon 404 receives the layer renewal command from the client 402. The docker daemon 404 includes the docker server 410 and an engine 412: The docker server 410 processes the command and interacts with the engine 412. The engine 412 includes the OPELRN engine 152, which is responsible for handling the renewal process. The engine 412 also manages various jobs 416 (Job0, Job2, … , JobM, JobN) that are executed as part of the renewal process.

The jobs 416 interact with registry 418 stores the container images and layers. The OPELRN engine 152 pulls the new target layer from the registry 418 as part of the renewal process.

The driver 406 includes various sub-drivers, including graphdriver 420, networkdriver 422, and execdriver 424, which are responsible for managing different aspects of the container’s operation. More particularly, graphdriver 420 manages the storage and retrieval of the container’s layers in the local graph 426, networkdriver 422 manages the network aspects of the container, and execdriver 424 manages the execution of processes within the container.

Graph 426 represents a local graph, which stores the container’s layers and their metadata locally.

Docker container 428 is an example of the container 210 and represents is the running instance of the container image 200, which includes the layers being managed and renewed by the system.

In summary, FIG. 4 depicts the architecture and flow of commands and data within the system 400 for renewing a specified layer with a new target layer using the OPELRN engine 152. The process starts with the client 402 sending a command, which is processed by docker daemon 404, docker server 410, and OPELRN engine 152. The OPELRN engine 152 then interacts with the registry 418, graph 426, and driver 406 to perform the renewal, ensuring that the docker container 428 continues to run with the applied fixes without needing to restart the container service.

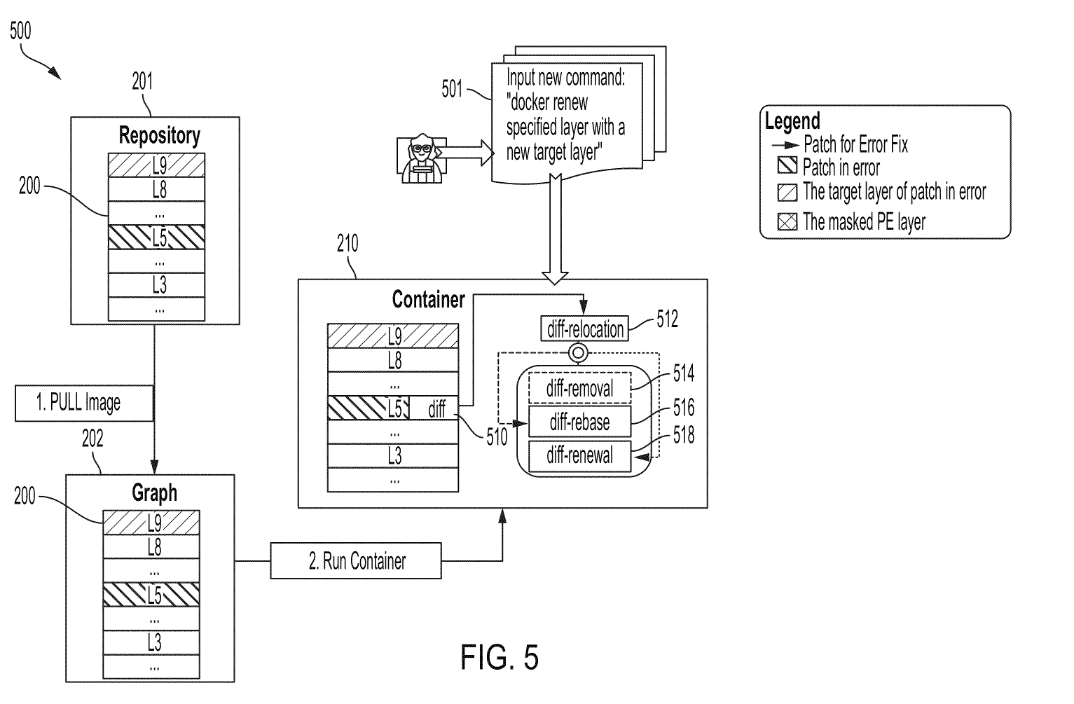

FIG. 5 illustrates a block diagram of an architecture 500 for renewing layers of a container without restarting according to an embodiment. The architecture 500 includes several components, including repository 201, local graph 202, and container 210. Repository 201 stores container image 200, which includes multiple layers (e.g., layers L3, L5, L8, and L9, among others). Layer L5 is a patch in error, and layer L9 is a fix for the patch in error of layer L5. The local graph 202 is where the container image 200 is pulled and stored locally to be executed as the container 210.

The process begins with the repository 201, where the container image 200 is stored. The container image 200 includes various layers, such as L3, L5 (Patch in Error, PE), L8, and L9. The first step involves pulling the image from the repository 201 to the local graph 202. This step ensures that the container image 200 and its layers are available locally for deployment and management.

Once the image is pulled to the local graph 202, the next step involves running the container 210. The container 210 is instantiated from the local graph 202 and includes the same layers as the container image 200. In this example, the container 210 includes layers L3, L5 (PE), L8, and L9. The layer L5 is identified as having a patch in error, which is to be corrected using a renewal approach as described herein (e.g., to be renewed with a new target layer (L9)).

The renewal process is initiated by inputting layer renewal command 501, which is represented as “docker renew specified layer with a new target layer.” Layer renewal command 501 is received by the system, which triggers the renewal process. Layer L5 (PE) of the container 210 includes a diff directory 510, which contains various attributes, such as diff-relocation 512, diff-removal 514, diff-rebase 516, and diff-renewal 518.

Diff directory 510 (also referred to simply as “diff”) refers to a folder that stores a “diffID” and is used to check layer items on a root file system via a command “docker inspect image layer checksum ID,” which is obtained by calculating a tar data checksum of the image layer “diff” folder. The diff directory 510 (or “diff”) stores information about the content of a layer, such as updated file, new file, removed file, directory file, and/or the like, including combinations and/or multiples thereof. The “diffID” is a unique identifier that identifies the layers of the image.

Diff-relocation 512 represents attributes, such as diff-relocation and diff-removal, for relocating a layer cacheID’s “diff”. Diff-removal 514 represents a diff-removal attribute that is used to mask a layer having a patch in error without waiting for a new fix version of the layer by making diff relocated to the diff-removal folder. Diff-rebase 516 represents a diff-rebase attribute that is used to rebase the layer having the patch in error without repulling the layer with the patch in error from a registry or redeploying the container with the layer patch in error by making the diff relocated to the diff-rebase folder.

Diff-renewal represents a diff-renewal attribute, which is created under the diff-relocation 512 attribute of the specified layer’s cacheID. The diff directory of the new target layer (L9) is moved under the cacheID of the specified layer (L5) with patch in error to the diff-renewal 518 attribute. The diff-relocation 512 attribute of the specified layer (L5) is then updated to point to the diff-renewal 518 attribute, effectively applying the fixes from the new target layer (L9) to the specified layer (L5) with the patch in error.

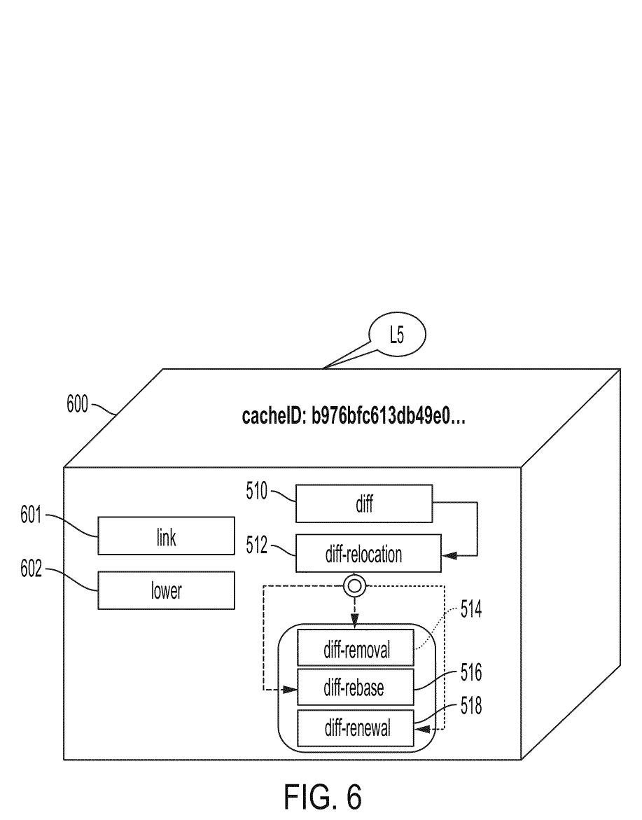

FIG. 6 illustrates a block diagram of a layer L5600 of an image having attributes for renewing layers of a container without restarting according to an embodiment. The diagram provides a detailed view of the internal structure and attributes associated with the layer L5600, which is identified by a cacheID (“b976bfc613db49e0...”). The layer L5600 contains several components and attributes that facilitate the renewal process.

The cacheID uniquely identifies the layer L5600. The layer L5600 includes diff directory 510, which is used for managing the differences between layers. Within the diff directory 510, there are several attributes, including diff-relocation 512, diff-removal 514, diff-rebase 516, and diff-renewal 518. These attributes are used to manage the state and transitions of the layer L5600 during the renewal process.

The diff-relocation 512 attribute is responsible for pointing to the current state of the layer’s diff data. In the renewal process, diff-renewal 518 is created under the diff-relocation 512 attribute. The diff-renewal 518 contains the renewal storage (fixes) for the layer with the patch in error (e.g., layer L5600). The diff folder of the new target layer (e.g., L9) is moved under the cacheID of the specified layer (e.g., layer L5600) to the diff-renewal 518 attribute. The diff-relocation 512 attribute is then updated to point to the diff-renewal 518 attribute, effectively applying the fixes from the new target layer (e.g., L9) to the specified layer (e.g., layer L5600).

The diagram also includes link 601 and lower 602 attributes, which are part of the metadata for layer L5600. The link 601 attribute represents the connection to other layers, while the lower 602 attribute indicates the lower layers in the hierarchy. These attributes help in managing the relationships and dependencies between different layers in the container image.

In summary, FIG. 6 provides a detailed view of the internal structure and attributes of a layer in a container image, highlighting the components and steps involved in the renewal process. The introduction of the diff-renewal 518 enables the renewal of layers with patches in error (e.g., layer L5600) without restarting the container service, thereby enhancing the robustness and security of enterprise-level production environments.

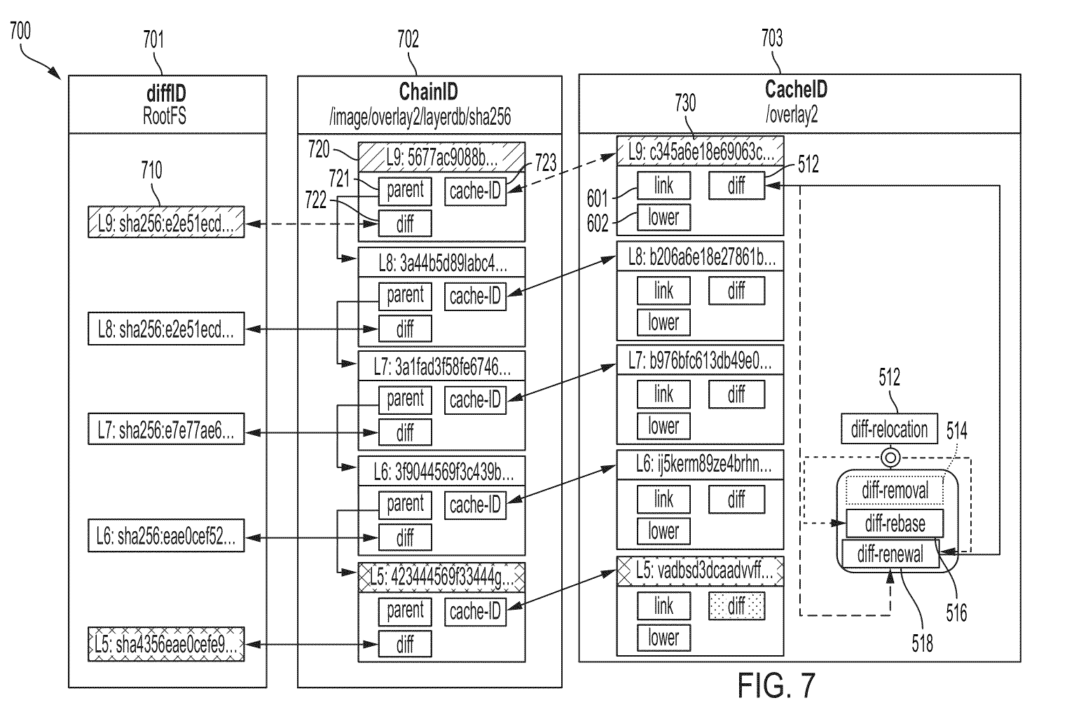

FIG. 7 illustrates a block diagram of a schema 700 for addressing of container layers with renewal layer for renewing layers of a container without restarting according to an embodiment. The schema 700 is divided into three main storage mechanisms: diffID 701, ChainID 702, and CacheID 703. Each storage mechanism represents different aspects of the container layer management and renewal process.

DiffID 701 shows the root filesystem (RootFS) and the various layers identified by their diffIDs. The layers include, for example, L9, L8, L7, L6, and L5. Each layer is represented by its unique diffID, such as “sha256:e2e51ecd...” for L9 and “sha4356eae0cefe9...” for L5. DiffID 701 provides a hierarchical view of the layers, with L5 identified as having a patch in error, and L9 identified as the fix for L5.

ChainID 702 provides a detailed view of the relationships between the layers. Each layer is represented by its chainID, which includes attributes, such as parent 721, diff 510, and cacheID 723. For example, L9 has a chainID of “5677ac9088b...” and includes a parent 721 attribute pointing to L8, a diff 510 attribute, and a cacheID 723 attribute. ChainID 702 shows the hierarchical relationships between the layers, with each layer building upon its parent layer. ChainID 702 also highlights the patch in error (L5) and its relationship with other layers.

CacheID 703 provides a detailed view of the cacheID 723 and the attributes associated with each layer. Each layer is represented by its cacheID, such as “c345a6e18e69063c...” for L9 and “vadbsd3dcaadvvff...” for L5. CacheID 703 includes attributes, such as link 601, lower 602, and diff directory 510. The diff directory 510 attribute is further divided into diff-relocation 512, which includes diff-removal 514, diff-rebase 516, and diff-renewal 518. Diff-renewal 518 is created under the diff-relocation 512 attribute for the specified layer (L5) to store the renewal data for the layer that fixes the patch in error (L9). The diff folder of the new target layer (L9) is moved under the cacheID of the specified layer (L5) to the diff-renewal 518 attribute. The diff-relocation 512 attribute is then updated to point to the diff-renewal 518 attribute, effectively applying the fixes from the new target layer (L9) to the specified layer (L5).

The diagram also includes visual connections between the sections, showing how the diffID 701, chainID 702, and cacheID 703 storage mechanisms are related and how the renewal process is managed.

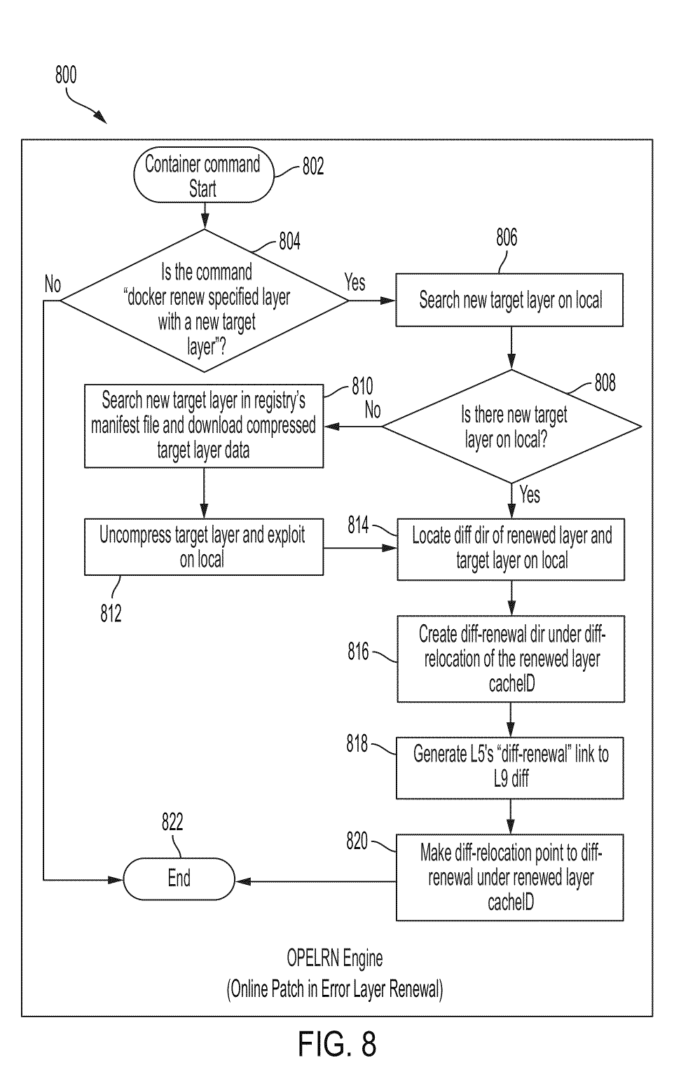

Turning now to FIG. 8, a flow diagram of a method 800 for renewing layers of a container without restarting is provided according to an embodiment. The method 800 can be performed by any suitable computing system, device, or environment, such as those described herein (e.g., the computing environment 100 and/or the computer 101 of FIG. 1). According to one or more embodiments, the method 800 is performed, in whole or in part, using container engine 150 (including the OPELRN engine 152) of FIG. 1.

The method 800 begins at block 802, where the OPELRN engine 152 receives a container command to start the process. This initial step involves preparing the system to execute the subsequent steps of the method 800.

At decision block 804, the OPELRN engine 152 determines whether the command is layer renewal command 501 (e.g., “docker renew specified layer with a new target layer”). If the command is not to renew a specified layer, the method 800 proceeds to block 822 and ends. If the command is layer renewal command 501 to renew a specified layer, the method 800 proceeds to block 806.

At block 806, the OPELRN engine 152 searches for the new target layer (e.g., L9 of FIG. 2) on local storage. This step involves checking if the new target layer, which includes fixes for the patch in error, is already available locally.

At decision block 808, the OPELRN engine 152 determines whether the new target layer is found on local storage (e.g., local graph 202). If the new target layer is not found locally, the method 800 proceeds to block 810. If the new target layer is found locally, the method proceeds to block 814.

At block 810, the OPELRN engine 152 searches for the new target layer in the registry’s manifest file and downloads the compressed target layer data. The manifest file includes information about an image, such as its size, layers, and digest. This step involves retrieving the new target layer from a remote registry (e.g., image repository 201) where it is stored. At block 812, the OPELRN engine 152 uncompresses the target layer and exploits it on local storage. This step involves preparing the new target layer for use by uncompressing it and making it available locally. The method 800 then advances to block 814.

At block 814, the OPELRN engine 152 locates the diff directory of the renewed layer and the target layer on local storage. This step involves identifying the specific directories where the diff data for the layers is stored.

At block 816, the method includes creating a “diff-renewal” directory (e.g., diff-renewal 518) under the “diff-relocation” attribute (e.g., diff-relocation 512) of the renewed layer’s cacheID (e.g., cacheID 730). This step involves setting up a new directory to store the renewal data for the layer with the patch in error.

At block 818, the OPELRN engine 152 generates the “diff-renewal” link for the specified layer (e.g., L5) to the new target layer’s diff (e.g., L9) or moves the new target layer’s diff (e.g., L9) to the “diff-renewal” of the specified layer (e.g., L5). This step involves linking the diff data of the new target layer to the specified layer with the patch in error.

At block 820, the method includes making the “diff-relocation” attribute (e.g., diff-relocation 512) of the specified layer point to the “diff-renewal” directory (e.g., diff-renewal 518) under the renewed layer’s cacheID. This step involves updating the attribute to point to the new renewal data, effectively applying the fixes to the specified layer.

The method 800 ends at block 822, where the method 800 terminates. This step signifies the successful renewal of the layer with the patch in error, allowing the container to continue running with the applied fixes.

Additional processes also may be included, and it should be understood that the processes depicted in FIG. 8 represent illustrations, and that other processes may be added or existing processes may be removed, modified, or rearranged without departing from the scope of the present disclosure. It should also be understood that the processes depicted in FIG. 8 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

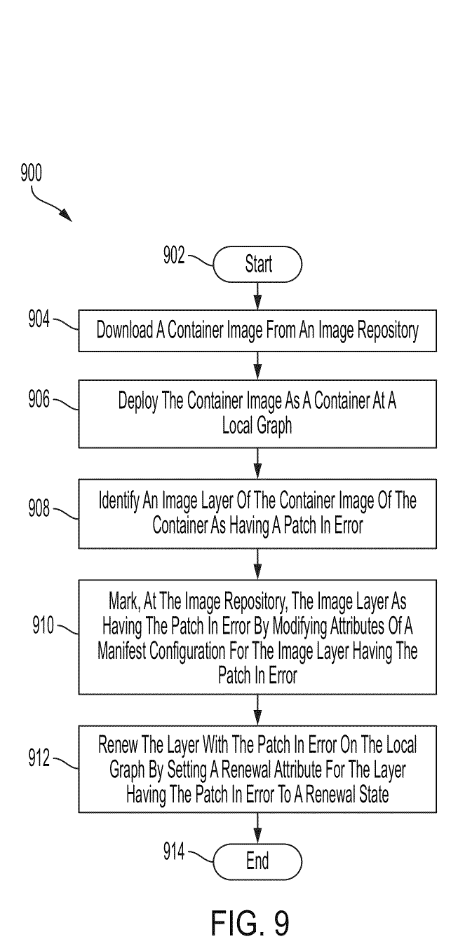

Turning now to FIG. 9, a flow diagram of a method 900 for renewing layers of a container without restarting is provided according to an embodiment. The method 900 can be performed by any suitable computing system, device, or environment, such as those described herein (e.g., the computing environment 100 and/or the computer 101 of FIG. 1). According to one or more embodiments, the method 900 is performed, in whole or in part, using container engine 150 (including the OPELRN engine 152) of FIG. 1.

The method 900 begins at block 902, where the process starts. This initial step involves preparing the system to execute the subsequent steps of the method 900.

At block 904, the method 900 includes downloading a container image (e.g., the container image 200) from an image repository (e.g., the image repository 201). This step involves retrieving the container image, which contains multiple layers, from a remote repository where it is stored. The image repository could be a public or private registry that stores container images for deployment.

At block 906, the method 900 includes deploying the container image as a container (e.g., the container 210) at a local graph (e.g., the local graph 202). This step involves instantiating the container image on a local system, creating a running container instance from the downloaded image. The local graph refers to the local storage structure where the container layers are managed.

At block 908, the method 900 includes identifying an image layer of the container image as having a patch in error (e.g., the layer L5 of the container image 200 / the container 210). This step involves detecting that a specific layer within the container image contains a patch that has introduced an error. This identification can be based on error reports, logs, or other diagnostic tools.

At block 910, the method 900 includes marking, at the image repository, the image layer as having the patch in error by modifying attributes of a manifest configuration for the image layer having the patch in error. This step involves updating the metadata or manifest configuration of the image layer in the repository to indicate that the layer (e.g., the layer L5) contains a patch in error. This marking helps in tracking and managing the erroneous layer.

At block 912, the method includes renewing the layer with the patch in error on the local graph by setting a renewal attribute for the layer having the patch in error to a renewal state. This step involves applying a fix to the erroneous layer by setting a new attribute, “diff-renewal,” under the cacheID of the layer having the patch in error (e.g., the layer L5). The renewal process relocates the layer’s diff folder to this new attribute “diff-renewal,” effectively updating the layer with the necessary fixes without restarting the container service.

The method 900 ends at block 914, where the method 900 is completed. This step signifies the successful renewal of the layer with the patch in error, allowing the container to continue running with the applied fixes.

Additional processes also may be included, and it should be understood that the processes depicted in FIG. 9 represent illustrations, and that other processes may be added or existing processes may be removed, modified, or rearranged without departing from the scope of the present disclosure. It should also be understood that the processes depicted in FIG. 9 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

One or more embodiments described herein improve the functioning of a computer by providing an efficient approach to renewing layers of a container without restarting the container service. This improvement is achieved through the introduction of a new attribute, “diff-renewal,” under the cacheID of the layer to be renewed and the relocation of the layer’s diff folder to this new attribute. The following highlight at least some of the ways how these embodiments enhance computer functionality.

One or more embodiments provides enhanced resource utilization. By renewing layers without restarting the container service, one or more embodiments provides reduce the need for multiple container instances. This leads to more efficient use of system resources, such as processing, memory, and storage, as the same container can be used to reproduce issues and verify fixes.

One or more embodiments provides reduced downtime. The ability to apply fixes to a layer with a patch in error without restarting the container service minimizes downtime. This is particularly useful in enterprise-level production environments where high availability and minimal disruption are desired.

One or more embodiments provides improved security. The quick and efficient renewal of layers with patches in error helps to promptly address security vulnerabilities. By applying fixes without delay, one or more embodiments provides reduce the window of exposure to potential security threats.

One or more embodiments provides simplified management. The introduction of the “diff-renewal” attribute and the associated command (e.g., “docker renew specified layer with a new target layer”) simplify the management of container layers. This streamlined approach reduces the complexity of handling patches and fixes, making it easier for administrators and developers to maintain containerized applications.

One or more embodiments provides consistency and reliability. The ability to reproduce issues and verify fixes on the same exploited container ensures consistency in testing and validation processes. This leads to more reliable outcomes, as the same environment is used for both identifying and resolving issues.

One or more embodiments provides compatibility with existing tools: The embodiments are designed to be compatible with current container tools. This ensures that the improvements can be seamlessly integrated into existing workflows without requiring significant changes to the underlying infrastructure.

One or more embodiments provides efficient layer management. The use of attributes, such as diff-relocation, diff-removal, diff-rebase, and diff-renewal, within the diff directory allows for granular control over the state and transitions of container layers. This efficient layer management contributes to the overall stability and performance of the containerized applications.

In summary, one or more of the embodiments described herein improve the functioning of a computer by enhancing resource utilization, reducing downtime, improving security, simplifying management, ensuring consistency and reliability, maintaining compatibility with existing tools, and providing efficient layer management. These improvements collectively contribute to a more robust and efficient containerized computing environment.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
downloading a container image from an image repository;
deploying the container image as a container at a local graph;
identifying an image layer of the container image of the container as having a patch in error;
marking, at the image repository, the image layer as having the patch in error by modifying attributes of a manifest configuration for the image layer having the patch in error; and
renewing the image layer with the patch in error on the local graph by setting a renewal attribute for the image layer having the patch in error to a renewal state.

2. The computer-implemented method of claim 1, further comprising marking the image layer as having the patch in error by modifying the attributes of the manifest configuration for the image layer.

3. The computer-implemented method of claim 1, wherein the renewing is performed responsive to receiving a layer renewal command.

4. The computer-implemented method of claim 1, the renewal attribute is stored in diff directory of the image layer that contains a fix for the patch in error to mask the image layer with the patch in error.

5. The computer-implemented method of claim 1, wherein the renewal attribute is associated with a cache identifier for the image layer that contains a fix for the patch in error.

6. The computer-implemented method of claim 1, wherein renewing the image layer comprises moving a diff folder for the image layer that contains a fix for the patch in error to the renewal attribute for the image layer having the patch in error.

7. The computer-implemented method of claim 6, wherein renewing the image layer further comprising making a diff relocation attribute for the image layer as having the patch in error point to the renewal attribute for the image layer as having the patch in error.

8. A computer system comprising:
a processor set;
one or more computer-readable storage media; and
program instructions stored on the one or more computer-readable storage media to cause the processor set to perform operations comprising:
downloading a container image from an image repository;
deploying the container image as a container at a local graph;
identifying an image layer of the container image of the container as having a patch in error;
marking, at the image repository, the image layer as having the patch in error by modifying attributes of a manifest configuration for the image layer having the patch in error; and
renewing the image layer with the patch in error on the local graph by setting a renewal attribute for the image layer having the patch in error to a renewal state.

9. The computer system of claim 8, wherein the operations further comprise marking the image layer as having the patch in error by modifying the attributes of the manifest configuration for the image layer.

10. The computer system of claim 8, wherein the renewing is performed responsive to receiving a layer renewal command.

11. The computer system of claim 8, the renewal attribute is stored in diff directory of the image layer that contains a fix for the patch in error to mask the image layer with the patch in error.

12. The computer system of claim 8, wherein the renewal attribute is associated with a cache identifier for the image layer that contains a fix for the patch in error.

13. The computer system of claim 8, wherein renewing the image layer comprises moving a diff folder for the image layer that contains a fix for the patch in error to the renewal attribute for the image layer having the patch in error.

14. The computer system of claim 13, wherein renewing the image layer further comprising making a diff relocation attribute for the image layer as having the patch in error point to the renewal attribute for the image layer as having the patch in error.

15. A computer program product comprising:
one or more computer-readable storage media; and
program instructions stored on the one or more computer-readable storage media to perform operations comprising:
downloading a container image from an image repository;
deploying the container image as a container at a local graph;
identifying an image layer of the container image of the container as having a patch in error;
marking, at the image repository, the image layer as having the patch in error by modifying attributes of a manifest configuration for the image layer having the patch in error; and
renewing the image layer with the patch in error on the local graph by setting a renewal attribute for the image layer having the patch in error to a renewal state.

16. The computer program product of claim 15, wherein the operations further comprise marking the image layer as having the patch in error by modifying the attributes of the manifest configuration for the image layer.

17. The computer program product of claim 15, wherein the renewing is performed responsive to receiving a layer renewal command.

18. The computer program product of claim 15, the renewal attribute is stored in diff directory of the image layer that contains a fix for the patch in error to mask the image layer with the patch in error.

19. The computer program product of claim 15, wherein the renewal attribute is associated with a cache identifier for the image layer that contains a fix for the patch in error.

20. The computer program product of claim 15, wherein renewing the image layer comprises moving a diff folder for the image layer that contains a fix for the patch in error to the renewal attribute for the image layer having the patch in error.
